(19) United States
(12) Patent Application Publication
(10) Pub. No.: US 2021/0095980 A1
(43) Pub. Date: Apr. 1, 2021

(54) ENHANCED LOCALIZATION

(71) Applicant: GM CRUISE HOLDINGS LLC, San Francisco, CA (US)

(72) Inventor: Shiva Ghose, Berkeley, CA (US)

(21) Appl. No.: 16/589,004

(22) Filed: Sep. 30, 2019

(51) Int. Cl. G01C 21/34; G06N 20/00; G01C 21/28; G01C 21/36

(52) U.S. Cl. CPC G01C 21/3438; G01C 21/36; G01C 21/28; G06N 20/00

(57) ABSTRACT

The subject disclosure relates to methods for performing accurate localization to facilitate autonomous vehicle (AV) navigation. Aspects of the disclosed technology include a method that includes steps for receiving a first feature set at an autonomous vehicle (AV) localization system, wherein the first feature set is transmitted to the AV localization system by a mobile device associated with an AV user, comparing the first feature set to a high-resolution map to determine a location of the mobile device, and transmitting the location of the mobile device to an autonomous vehicle (AV) that is en route to the AV user. Systems and machine-readable media are also provided.

### BACKGROUND

### 1. Technical Field

The subject technology provides solutions for performing localization on a mobile device and in particular, for using extracted image features to perform localization using a high resolution Light Detection and Ranging (LiDAR) map.

### 2. Introduction

Autonomous vehicles (AVs) are vehicles having computers and control systems that perform driving and navigation tasks that are conventionally performed by a human driver. As AV technologies continue to advance, ride-sharing services will increasingly utilize AVs to improve service efficiency and safety. However, for effective use in ride-sharing deployments, AVs will be required to perform many of the functions that are conventionally performed by human drivers, such as finding riders/users of the AV service from among multiple people in a pick-up zone.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the subject technology. In the drawings:

FIG. 1 illustrates a block diagram of an example localization system, according to some aspects of the disclosed technology.

FIG. 2 illustrates an example signaling diagram that represents signaling used to implement a localization process, according to some aspects of the disclosed technology.

FIG. 3 illustrates steps of an example localization method, according to some aspects of the disclosed technology.

FIG. 4 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

In conventional ride-hailing deployments, where vehicles are operated by human drivers, riders (users) and drivers frequently communicate for the purpose of coordinating rider pick-up. The pick-up process is especially difficult in situations where many people are in a vicinity of the rider's pick-up location, such as outside a busy venue, or at an airport curbside. As such, rider/driver communications are often needed to help the driver pinpoint a precise rendezvous location. Because AV deployments lack human drivers with which riders can communicate, it would be advantageous to provide improved localization capabilities so that AVs can accurately find the rider amongst a morass of pedestrians.

Aspects of the disclosed technology address the foregoing limitations of AV ride hailing deployments by providing high-accuracy device localization. Localization methods of the disclosed technology can be performed to determine a precise location of a mobile device (e.g., smart phone, tablet computer, or other processor-based wireless devices), and/or an autonomous vehicle. Although the localization methods disclosed herein are provided in the context of a few specific examples, it is understood that the disclosed descriptions not limited to these examples, and that other implementations are contemplated by this disclosure.

In some aspects, localization methods of the disclosed technology make use of high-fidelity Light Detection and Ranging (LiDAR) maps that can be used to accurately determine the location of the mobile device based on images of the environment around the mobile device. As discussed in further detail below, resolving coordinate matches between mobile device images (i.e., image features), and a high-fidelity LiDAR map can be based on image heuristics, or performed using a machine learning implementation.

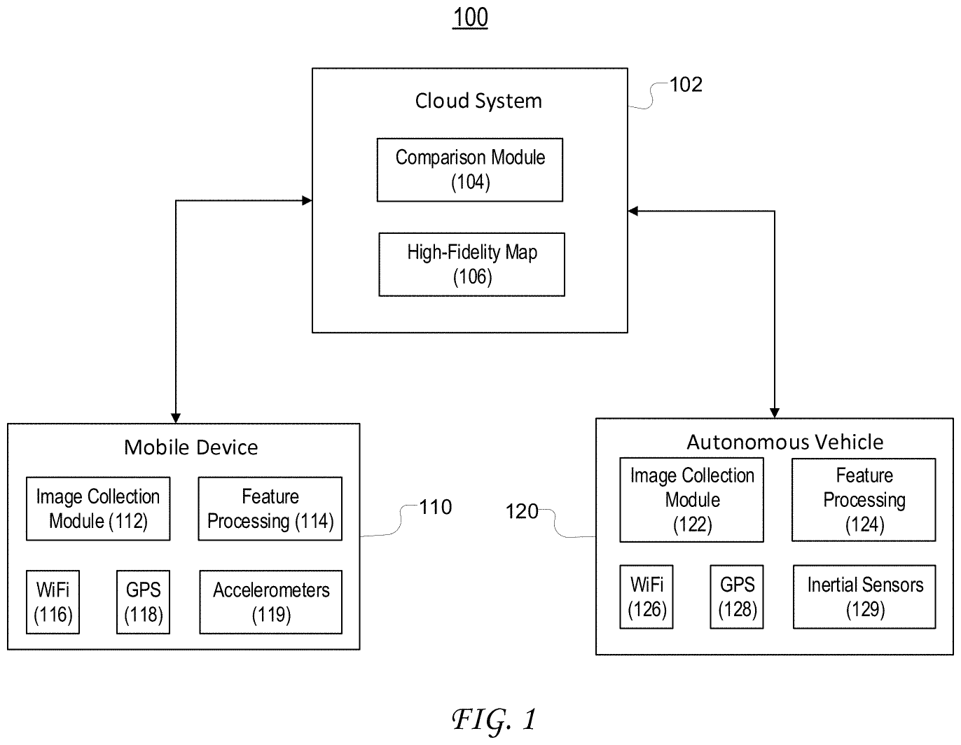

Turning now to the figures, FIG. 1 illustrates a block diagram of an example localization system 100, according to some aspects of the disclosed technology. Localization system 100 includes a cloud system 102 that is communicatively coupled to a mobile device 110, and an autonomous vehicle 120, for example, via one or more wired and/or wireless networks, such as the Internet. Cloud system 102 includes comparison module 104, and high-fidelity map 106. Mobile device 110 includes image collection module 112, feature processing module 114, Wi-Fi module 116, GPS module 118, and one or more accelerometers 120. Autonomous vehicle (AV) 120 includes an image collection module 122, feature processing module 124, Wi-Fi module 126, GPS module 128, and inertial sensors (e.g. and inertial measurement unit) 129. It is understood that cloud system 102, mobile device 110, and AV 120 are illustrated representations of some hardware components that may be used to implement aspects of the invention; however, other hardware devices may be used without departing from the scope of the disclosed technology.

In practice, cloud system 102 can be configured to accurately determine a location of mobile device 110, and/or AV 120, based on image data for the respectively surrounding areas. For example, image collection module 112 can be used to collect images for an environment associated with (surrounding) mobile device 110, and image collection module 122 can be used to collect images of the environment surrounding AV 120. Image collection modules 112, 122, can include charge-coupled devices (CCD chips), such as cameras configured to receive and process images of environment surrounding mobile device 110 and/or AV 120. The collected images can include static images such as panoramic images, or video feeds collected by image collection modules 112, 122.

Image data collected by image collection modules 112, 122 can then be processed to extract image features e.g., by respective feature processing modules 114, 124. The extracted feature sets serve as unique digital “fingerprints,” used to identify an associated map location. In some aspects, feature processing may include an inverse perspective mapping transformation, for example, to extract features representing a top-down view of the corresponding map region. Feature sets extracted from collected images (e.g., by feature processing modules 114, 124), are provided to cloud system 102 and used to determine a precise locations of mobile device 110 and/or AV 120. In some aspects, the feature sets may be compressed using a data compression scheme before being transmitted to cloud system 102.

Feature sets received at cloud system 102 are processed using comparison module 104 and high-fidelity map 106. In some approaches, comparison module 104 can be configured to process the received feature sets and make comparisons to high-fidelity map 106, for example, to determine locations on map 106 that correspond with the feature sets. In some aspects, comparison module 104 may utilize a data correlation algorithm, such as a Pearson correlation function, to identify map locations corresponding with the received feature set.

In other aspects, comparison module 104 may utilize a machine learning model to match (classify) feature sets (input) into an output (map location) on high-fidelity map 106. As understood by those of skill in the art, machine-learning based classification techniques can vary depending on the desired implementation. For example, machine-learning classification schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: Stochastic Gradient Descent Regressors, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

In some approaches, the localization process performed by cloud system 102 can benefit from data segmentation. For example, feature set data received at cloud system 102 may include additional location information, such as WiFi location data (collected using one or more of WiFi modules 116, 126), GPS location data (collected using one or more of GPS module 118), 128 and/or accelerometer data (collected using device accelerometers 119 of mobile device 120, and/or inertial sensors 129 of AV 120. With the benefit of additional location information (e.g., WiFi, GPS and/or accelerometer data), high-fidelity map 106 can be segmented such that comparisons between the received feature set are only attempted against portions of the map most likely to contain the matching location. In this manner, segmentation may be used to improve the speed and efficiency of the localization processing performed by cloud localization system 102.

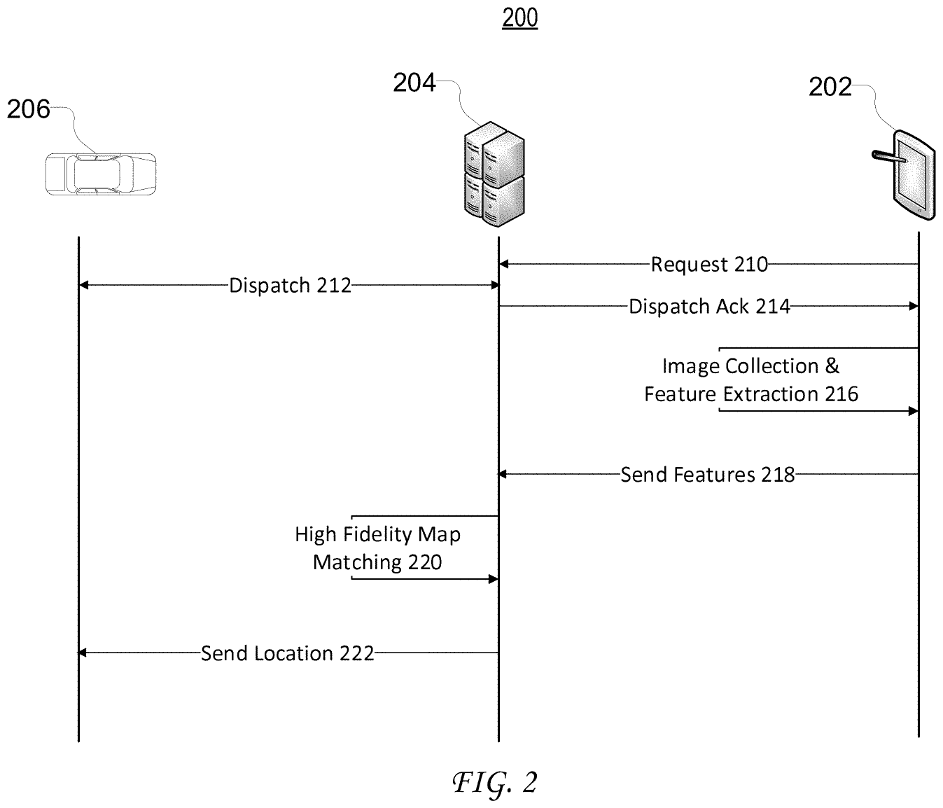

FIG. 2 illustrates an example signaling diagram 200 that represents signaling used to implement a localization process. In particular, signaling diagram illustrates example communications between a mobile device 202, a cloud system 204, and an AV 206. The ride hailing process can begin when a ride request 210 is transmitted from mobile device 202 to cloud system 204, thereby causing a dispatch request 212 to be sent from cloud system 204 to AV 206. Once AV 206 acknowledges dispatch 212, cloud system 204 provides an indication of the dispatch acknowledgement 214 to mobile device 202.

Next, image collection and feature extraction 216 is performed by mobile device 202. In some implementations, image collection is performed with the help of an associated user (e.g., a rider), for example, when the user holds out mobile device 202 out to capture images of his/her surrounding environs. In some aspects, the localization process is benefitted from larger image areas. As such, the user may be encouraged to capture larger amounts of surrounding image area, for example, by panning the image frustum to capture panoramic image sizes.

The captured images can then be processed locally (on mobile device 202) to extract image features that uniquely represent the capture image data. The resulting feature set is then transmitted 218 back to cloud system 204, where it is compared to a high-fidelity map 220 to determine a location of mobile device 202. Subsequently, the precise location of mobile device 202 is sent from cloud system 204 to AV 206. By knowing the precise location of mobile device 202 (and thereby the associated user), AV 206 can better locate the user, for example, in a pick-up scenario where other pedestrians may be present in a vicinity of the pick-up location.

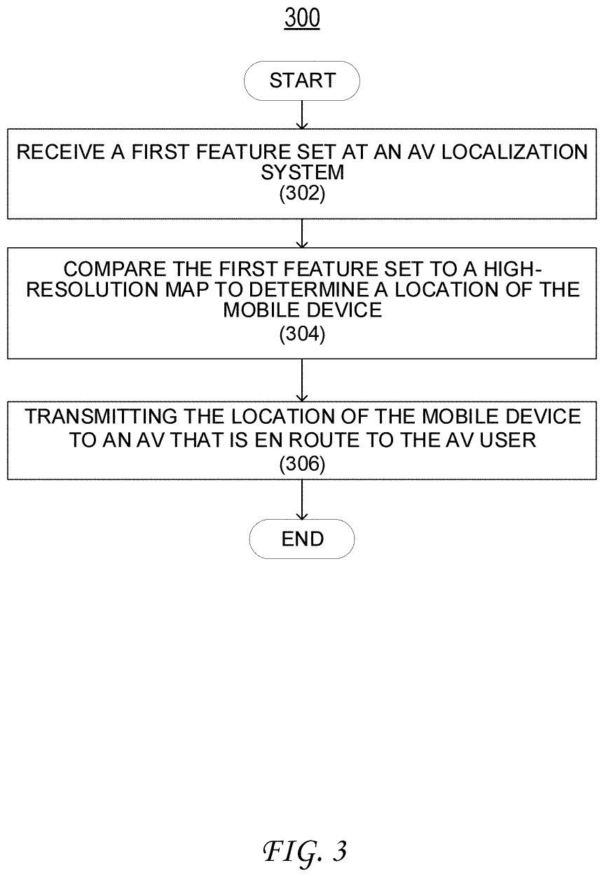

FIG. 3 illustrates steps of an example localization process 300, according to some aspects of the disclosed technology. Process 300 begins with step 302 in which a first feature set is received at an AV localization system. Further to the above examples, the first feature set can include image features extracted from one or more images collected by a mobile device. In some aspects, the feature set may include additional location information, including but not limited to WiFi position information, GPS coordinate data, and/or accelerometer data.

In step 304, the first feature set is compared to a high-resolution (LiDAR) map to determine a location associated with the mobile device. As discussed above, comparisons between the feature set and the high-resolution map can be performed using image matching techniques, such as using a Pearson correlation algorithm. In other approaches, a machine-learning model may be used to map the received feature set onto the high-resolution map.

After a position associated with the mobile device has been accurately determined, the location can be transmitted to an AV, for example, that is en route to a rider/user associated with the mobile device (306). By providing high accuracy location information of the mobile device, the responding AV can more effectively arrive at a pick-up location of the user, thereby providing an improved pick-up experience.

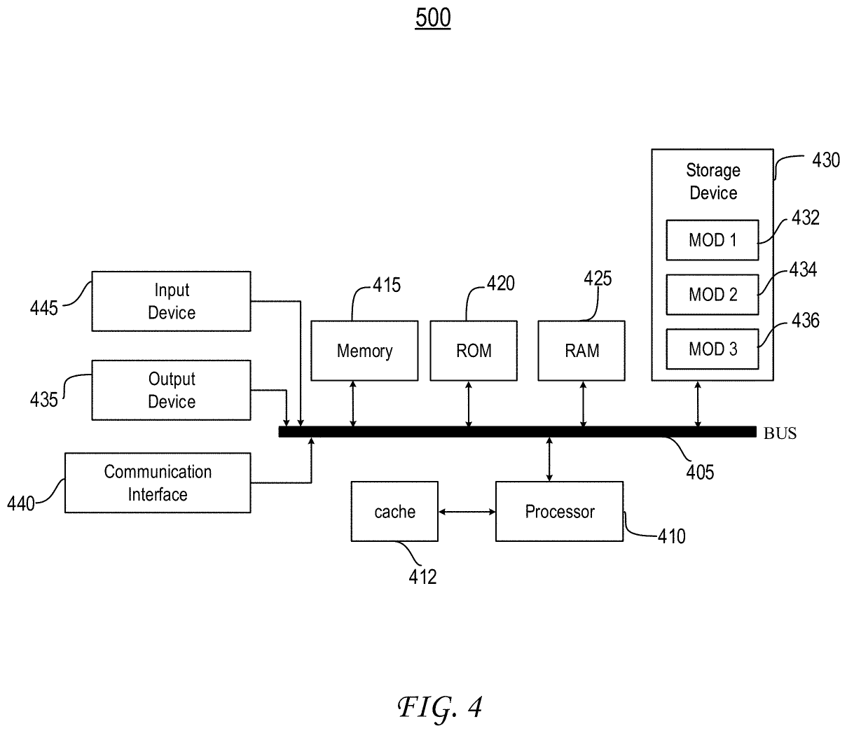

FIG. 4 illustrates an example processor-based system with which some aspects of the subject technology can be implemented. Specifically, FIG. 4 illustrates system architecture 400 wherein the components of the system are in electrical communication with each other using a bus 405. System architecture 400 can include a processing unit (CPU or processor) 410, as well as a cache 412, that are variously coupled to system bus 405. Bus 405 couples system components including system memory 415, (e.g., read only memory (ROM) 420 and random-access memory (RAM) 425, to processor 410.

System architecture 400 can include a cache of high-speed memory connected directly with, in close proximity to, or integrated as part of the processor 410. System architecture 400 can copy data from the memory 415 and/or the storage device 430 to the cache 412 for quick access by the processor 410. In this way, the cache can provide a performance boost that avoids processor 410 delays while waiting for data. These and other modules can control or be configured to control the processor 410 to perform various actions. Other system memory 415 may be available for use as well. Memory 415 can include multiple different types of memory with different performance characteristics. Processor 410 can include any general purpose processor and a hardware module or software module, such as module 1 (432), module 2 (434), and module 3 (436) stored in storage device 430, configured to control processor 410 as well as a special-purpose processor where software instructions are incorporated into the actual processor design. Processor 410 may essentially be a completely self-contained computing system, containing multiple cores or processors, a bus, memory controller, cache, etc. A multi-core processor may be symmetric or asymmetric.

To enable user interaction with the computing system architecture 400, an input device 445 can represent any number of input mechanisms, such as a microphone for speech, a touch-sensitive screen for gesture or graphical input, keyboard, mouse, motion input, speech and so forth. An output device 435 can also be one or more of a number of output mechanisms. In some instances, multimodal systems can enable a user to provide multiple types of input to communicate with the computing system architecture 400. Communications interface 440 can generally govern and manage the user input and system output. There is no restriction on operating on any particular hardware arrangement and therefore the basic features here may easily be substituted for improved hardware or firmware arrangements as they are developed.

Storage device 430 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 425, read only memory (ROM) 420, and hybrids thereof.

Storage device 430 can include software modules 432, 434, 436 for controlling processor 410. Other hardware or software modules are contemplated. Storage device 430 can be connected to the system bus 405. In one aspect, a hardware module that performs a particular function can include the software component stored in a computer-readable medium in connection with the necessary hardware components, such as the processor 410, bus 405, output device 435, and so forth, to carry out various functions of the disclosed technology.

By way of example, instruction stored on computer-readable media can be configured to cause one or more processors to perform operations including: receiving a first feature set at an autonomous vehicle (AV) localization system, wherein the first feature set is transmitted to the AV localization system by a mobile device associated with an AV user, comparing the first feature set to a high-resolution map to determine a location of the mobile device, and transmitting the location of the mobile device to an autonomous vehicle (AV) that is en route to the AV user. In some aspects, the high-resolution map comprises a Light Detection and Ranging (LiDAR) map. In some aspects, comparing the first feature set to the high-resolution map further includes steps for processing the first feature set using a machine-learning model to determine the location of the mobile device.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

What is claimed is:

1. A computer-implemented method for performing localization, comprising:
receiving a first feature set at an autonomous vehicle (AV) localization system, wherein the first feature set is transmitted to the AV localization system by a mobile device associated with an AV user;
comparing the first feature set to a high-resolution map to determine a location of the mobile device; and
transmitting the location of the mobile device to an autonomous vehicle (AV) that is en route to the AV user.

2. The computer-implemented method of claim 1, wherein the high-resolution map comprises a Light Detection and Ranging (LiDAR) map.

3. The computer-implemented method of claim 1, wherein the first feature set is derived from images collected by the mobile device.

4. The computer-implemented method of claim 1, wherein comparing the first feature set to the high-resolution map further comprises:
processing the first feature set using a machine-learning model to determine the location of the mobile device.

5. The computer-implemented method of claim 1, further comprising:
receiving a second feature set at the AV localization system, wherein the second feature set is transmitted to the AV localization system by the AV that is en route to the AV user.

6. The computer-implemented method of claim 1, wherein the first feature set comprises Global Positioning System (GPS) coordinates of the mobile device, and
wherein comparing the first feature set to the high-resolution map further comprises segmenting the high-resolution map using the GPS coordinates of the mobile device.

7. The computer-implemented method of claim 1, wherein comparing the first feature set to the high-resolution map is performed using a bivariate correlation calculation.

8. A system for performing mobile device localization, comprising:
one or more processors; and
a computer-readable medium comprising instructions stored therein, which when executed by the processors, cause the processors to perform operations comprising:
receiving a first feature set at an autonomous vehicle (AV) localization system, wherein the first feature set is transmitted to the AV localization system by a mobile device associated with an AV user;
comparing the first feature set to a high-resolution map to determine a location of the mobile device; and
transmitting the location of the mobile device to an autonomous vehicle (AV) that is en route to the AV user.

9. The system of claim 8, wherein the high-resolution map comprises a Light Detection and Ranging (LiDAR) map.

10. The system of claim 8, wherein the first feature set is derived from images collected by the mobile device.

11. The system of claim 8, wherein comparing the first feature set to the high-resolution map further comprises:
processing the first feature set using a machine-learning model to determine the location of the mobile device.

12. The system of claim 8, wherein the processors are further configured to perform operations comprising:
receiving a second feature set at the AV localization system, wherein the second feature set is transmitted to the AV localization system by the AV that is en route to the AV user.

13. The system of claim 8, wherein the first feature set comprises Global Positioning System (GPS) coordinates of the mobile device, and
wherein comparing the first feature set to the high-resolution map further comprises segmenting the high-resolution map using the GPS coordinates of the mobile device.

14. The system of claim 8, wherein comparing the first feature set to the high-resolution map is performed using a bivariate correlation calculation.

15. A non-transitory computer-readable storage medium comprising instructions stored therein, which when executed by one or more processors, cause the processors to perform operations comprising:
receiving a first feature set at an autonomous vehicle (AV) localization system, wherein the first feature set is transmitted to the AV localization system by a mobile device associated with an AV user;
comparing the first feature set to a high-resolution map to determine a location of the mobile device; and
transmitting the location of the mobile device to an autonomous vehicle (AV) that is en route to the AV user.

16. The non-transitory computer-readable storage medium of claim 15, wherein the high-resolution map comprises a Light Detection and Ranging (LiDAR) map.

17. The non-transitory computer-readable storage medium of claim 15, wherein the first feature set is derived from images collected by the mobile device.

18. The non-transitory computer-readable storage medium of claim 15, wherein comparing the first feature set to the high-resolution map further comprises:
processing the first feature set using a machine-learning model to determine the location of the mobile device.

19. The non-transitory computer-readable storage medium of claim 15, wherein the processors are further configured to perform operations comprising:
receiving a second feature set at the AV localization system, wherein the second feature set is transmitted to the AV localization system by the AV that is en route to the AV user.

20. The non-transitory computer-readable storage medium of claim 15, wherein the first feature set comprises Global Positioning System (GPS) coordinates of the mobile device, and
wherein comparing the first feature set to the high-resolution map further comprises segmenting the high-resolution map using the GPS coordinates of the mobile device.
